(19) United States
(12) Patent Application Publication
(10) Pub. No.: US 2025/0110876 A1
(43) Pub. Date: Apr. 3, 2025

(54) DYNAMIC CACHE FILL PRIORIZATION

(71) Applicant: Intel Corporation, Santa Clara, CA (US)

(72) Inventors: Ashmita Sinha, New Delhi (IN); Joseph Nuzman, Haifa (IL)

(73) Assignee: Intel Corporation, Santa Clara, CA (US)

(21) Appl. No.: 18/477,207

(22) Filed: Sep. 28, 2023

(51) Int. Cl. G06F 12/0811

(52) U.S. Cl. CPC G06F 12/0811

(57) ABSTRACT

Techniques for dynamic cache fill prioritization are described. In an embodiment, an apparatus includes a cache at a mid-level of a cache hierarchy; and a mid-level cache (MLC) unit including the cache, a local queue to store MLC lookup requests, an external queue to store MLC fill requests, and an MLC access control hardware. The MLC access control hardware is to dynamically switch prioritization of servicing the MLC lookup requests versus servicing the MLC fill requests.

### BACKGROUND

Computers and other information processing systems may include multiple cache memories arranged hierarchically to provide access to data with lower latency than the latency of transactions to main system memory.

### BRIEF DESCRIPTION OF DRAWINGS

Various examples in accordance with the present disclosure will be described with reference to the drawings, in which:

FIG. 1 illustrates a cache architecture for dynamic cache fill prioritization according to an embodiment.

FIG. 2 illustrates a processor core supporting dynamic cache fill prioritization according to an embodiment.

FIG. 3 illustrates a method for dynamic cache fill prioritization according to an embodiment.

FIG. 4 illustrates an example computing system.

FIG. 5 illustrates a block diagram of an example processor and/or System on a Chip (SoC) that may have one or more cores and an integrated memory controller.

FIG. 6A is a block diagram illustrating both an example in-order pipeline and an example register renaming, out-of-order issue/execution pipeline according to examples.

FIG. 6B is a block diagram illustrating both an example in-order architecture core and an example register renaming, out-of-order issue/execution architecture core to be included in a processor according to examples.

FIG. 7 illustrates examples of execution unit(s) circuitry.

FIG. 8 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for dynamic cache fill prioritization. According to some examples, an apparatus includes a cache at a mid-level of a cache hierarchy; and a mid-level cache (MLC) unit including the cache, a local queue to store MLC lookup requests, an external queue to store MLC fill requests, and an MLC access control hardware. The MLC access control hardware is to dynamically switch prioritization of servicing the MLC lookup requests versus servicing the MLC fill requests.

As mentioned in the background section, a computer system may include multiple cache memories arranged hierarchically to provide access to data with lower latency than the latency of transactions to main system memory. For example, a cache hierarchy may include a level 0 (L0) cache, a level 1 (L1) cache, and a level 2 (L2) or mid-level cache (MLC) residing within a processor core, plus a level 3 (L3) or last level cache (LLC) outside the processor core (e.g., in an uncore or system agent).

In such computer systems, as new generations of processor cores' performance improves, data transfer or memory bandwidth becomes an increasingly critical metric for the overall performance of the system. Cores may try to hide the memory latency (and L3 latency in LLC bound traffic) by prefetching ahead of demand streams. However, even with prefetching, the available memory bandwidth per core may not be fully utilized (e.g., there may be a difference in theoretical maximum achievable memory bandwidth versus actual memory bandwidth). The use of embodiments may be desired as a potential approach to reducing the gap between theoretical and actual by addressing a bottleneck that may degrade actual memory bandwidth. One such embodiment will be described using, as an example, dynamic cache fill priority inversion for an MLC within in a core as an approach to address an intra-core bottleneck. However, embodiments are not limited to MLCs or MLCs within cores.

In the following description (and/or elsewhere) based on an MLC within a core, intra-die interconnect (IDI) bandwidth and memory bandwidth may be used interchangeably and/or referred to simply as bandwidth. Use of embodiments may be desired (e.g., in streaming applications where MLC queues may be a bottleneck in fetching streams from memory and/or the LLC) because it may increase actual bandwidth by providing more efficient utilization of MLC queue occupancy (as described below).

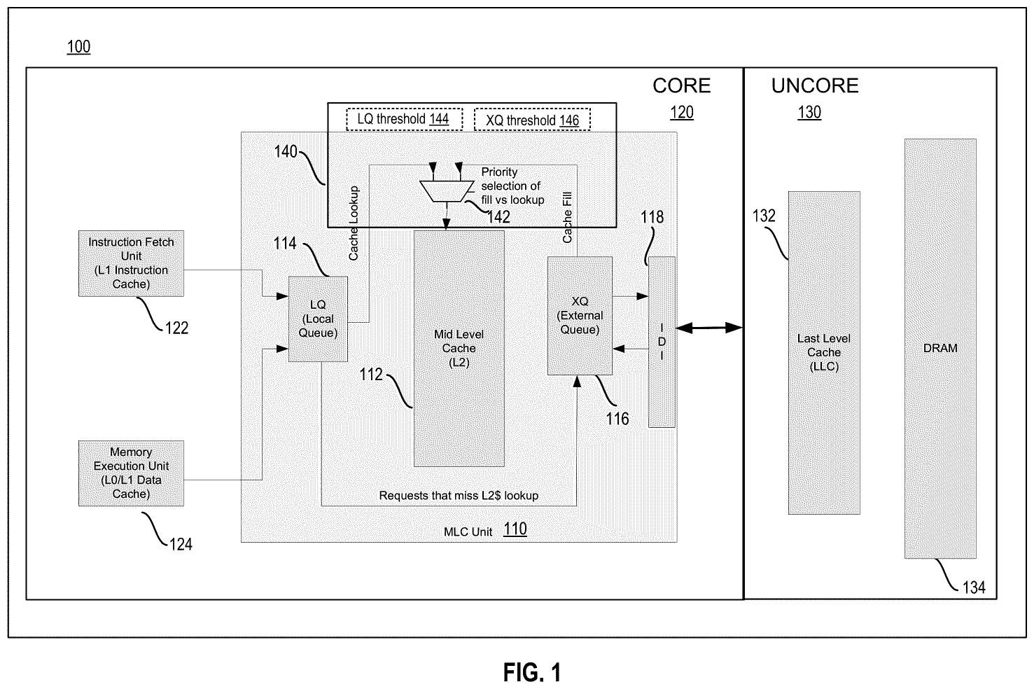

FIG. 1 illustrates a cache architecture 100 for dynamic cache fill prioritization according to an embodiment. In FIG. 1, MLC unit 110 resides within core 120, and includes MLC 112, local queue (LQ) 114, external queue (XQ) 116, and MLC access control hardware 140. Local queue 114 is connected to instruction fetch unit 122, which includes an L1 instruction cache, and to memory execution unit 124, which includes an L0/L1 data cache. External queue 116 is connected through IDI 118 to LLC 132 in uncore 130 (where uncore may refer to a system agent and/or any circuitry and/or logic within a chip (e.g., a processor chip or system on a chip (SoC)) but outside of a core). LLC 132 is connected to system memory (e.g., dynamic random access memory (DRAM) 134).

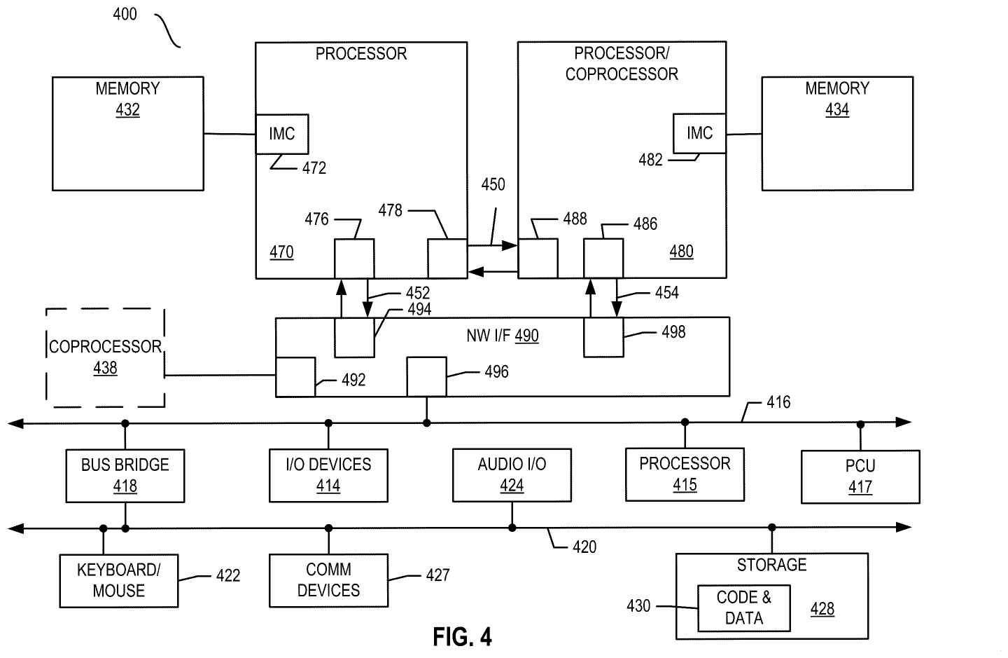

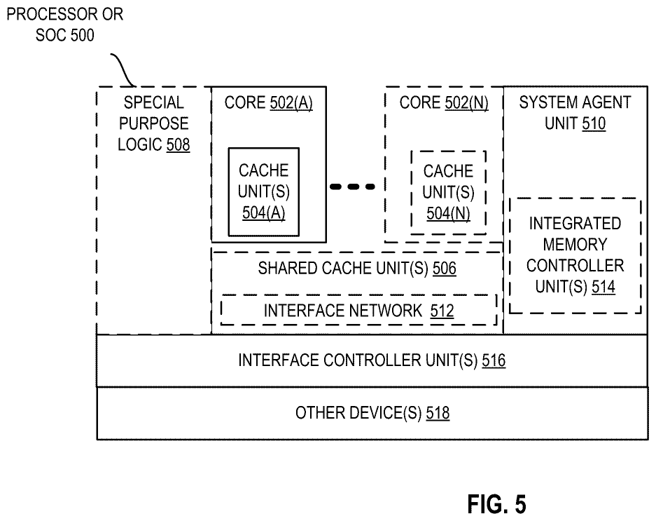

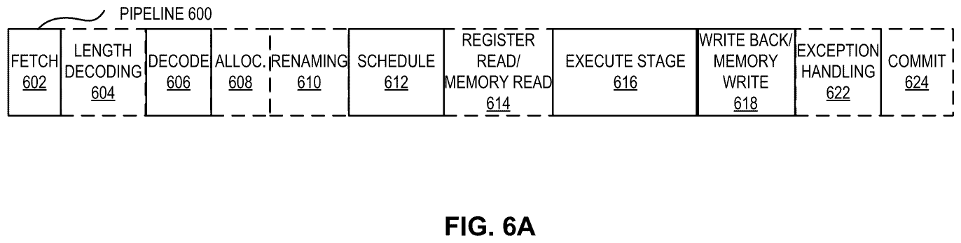

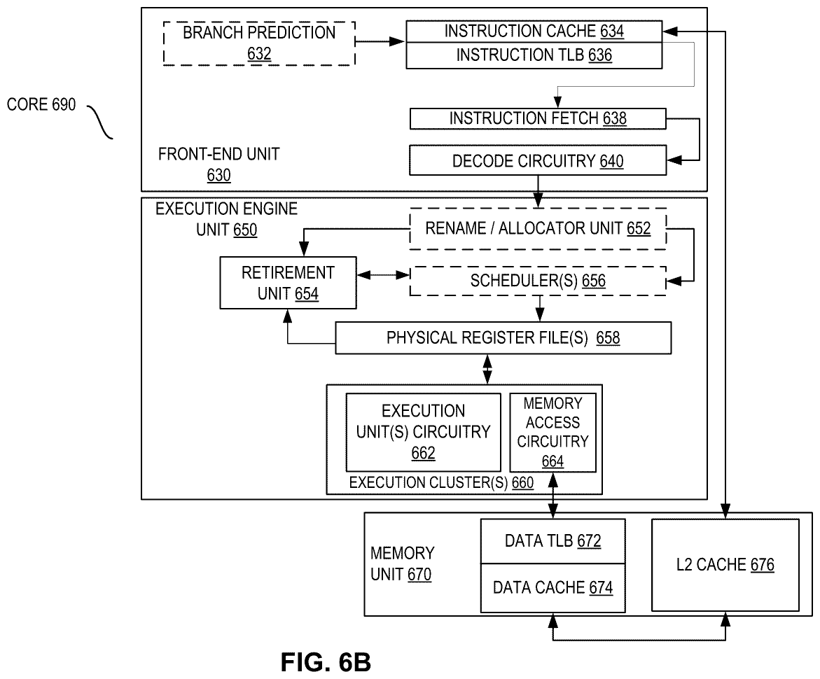

Cache architecture 100 may be implemented in a computer system (e.g., in any of processors 470, 480, or 415 in system 400 in FIG. 4, processor 500 or one of cores 502A to 502N in FIG. 5, and/or core 690 in FIG. 6B, each as described below) in such as multiprocessor system 400 in FIG. 4, in circuitry, gates, logic, structures, hardware, etc., all or parts of which may be included in a discrete component and/or integrated into the circuitry of a processing device or any other apparatus in a computer or other information processing system. For example, MLC unit 110 may represent all or part of cache unit(s) 504(A) to 504(N) in FIG. 5 or L2 cache 676 in FIG. 6, each as described below.

In embodiments, MLC unit 110 may handle transactions (e.g., data/code loads and stores), whether cacheable or uncacheable, going in and out of core 120. Local queue 114 and external queue 116 handle the lifetimes of in-flight requests for data/code from the nucleus (e.g., instruction fetch unit 122 and memory execution unit 124) of core 120.

MLC unit 110 may maintain a pipeline for MLC lookups (e.g., from the nucleus core) and MLC fills (e.g., with data from the LLC or DRAM). Typically, lookups may take priority over fills, unless fill requests become starved for a defined number of cycles. When traffic is uncore-bound (i.e., more MLC misses than hits), starving fills may increase the lifetime of requests (e.g., delay completion), thereby resulting in higher occupancy of the queues and lowering the rate at which requests can go out to the LLC/DRAM, which in turn lowers bandwidth consumption from the core.

Embodiments may provide more efficient utilization of queue occupancy within the MLC, by dynamically switching between cache lookup and cache fill actions, depending on the type of workload. For example, cache fill may take priority over cache lookups (without starving lookups) for streaming operations. This policy (fills having priority over lookups) may be referred to as priority inversion, since it is the opposite of the typical policy discussed above. However, for applications that are getting hits within the MLC, lookups should take higher priority. By dynamically changing the fill policy instead of using a static fill policy, actual bandwidth may be increased.

MLC access control hardware 140 may include circuitry, such as multiplexer 142, to access and/or control access to MLC 112. In an embodiment, MLC access control hardware 140 provides for dynamically switching the priority (e.g., the priority of servicing) of fills versus lookups within the MLC pipeline, to try to optimize queue occupancy. The rate of requests being serviced from the MLC versus going out to the LLC/DRAM may be inferred based on the life of requests in the external queue. In embodiments, two programmable thresholds are defined: a local queue threshold for the number (or lifetime) of pending MLC lookup requests from the nucleus core and an external queue threshold for the number (or lifetime) of pending requests that missed the MLC and are going out to the LLC/DRAM. If the number of requests pending fill into the MLC is above the external queue threshold, it may be inferred that traffic is memory bound and fills should get a higher priority than lookups (since there is a higher probability that a lookup will result in a miss). The priority may be switched back once the number of pending fills falls below the external queue threshold or if the number of requests from the nucleus core pending an MLC lookup increase above the local queue threshold (indicating lookups are being starved).

Accordingly, multiplexer 142 may select between a cache lookup and a cache fill based, at least in part, on a comparison (e.g., by first comparator circuitry) between the local queue threshold (represented by LQ threshold 144) and the local queue occupancy (e.g., number (or lifetime) of requests pending in the local queue) and/or a comparison (e.g., by second comparator circuitry) the external queue threshold (represented by XQ threshold 146) and the external queue occupancy (e.g., number (or lifetime) of requests pending in the external queue).

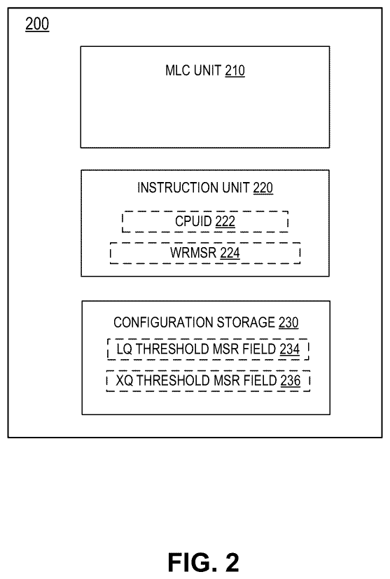

To provide for adjusting, tuning, etc. (e.g., based on type of workload, quality of service (QoS) considerations, etc.) of dynamic cache fill prioritization according to embodiments, one or both of the local queue threshold and the external queue threshold may be programmable. For example, LQ threshold 144 and XQ threshold 146 as shown in FIG. 1 may represent values programmed into registers or other storage within or accessible to MLC unit 110, as illustrated in FIG. 2 and described below.

Cache architecture 100 may be implemented in a processor, processor core, execution core, etc. which may be any type of processor/core, including a general-purpose microprocessor/core, such as a processor/core in the Intel® Core® Processor Family or other processor family from Intel® Corporation or another company, a special purpose processor or microcontroller, or any other device or component in an information processing system in which an embodiment may be implemented.

For example, FIG. 2 illustrates a processor or processor core 200 (which may represent any of processors 470, 480, or 415 in system 400 in FIG. 4, processor 500 or one of cores 502A to 502N in FIG. 5, and/or core 690 in FIG. 6B) supporting dynamic cache fill prioritization according to an embodiment. For convenience and/or examples, some features (e.g., instructions) may be referred to by a name associated with a specific processor architecture (e.g., Intel® 64 and/or IA32), but embodiments are not limited to those features, names, architectures, etc.

As shown, processor core 200 includes MLC unit 210 (which may correspond to MLC unit 110 in FIG. 1), instruction unit 220, and configuration storage (e.g., model or machine specific registers (MSRs)) 230, and any other elements (e.g., one or more execution units) not shown in FIG. 2.

Instruction unit 220 may correspond to and/or be implemented/included in front-end unit 630 in FIG. 6B, as described below, and/or may include any circuitry, logic gates, structures, and/or other hardware, such as an instruction decoder, to fetch, receive, decode, interpret, schedule, and/or handle instructions or programming mechanisms, such as a processor identification instruction (e.g., CPUID as described below) represented as block 222 and one or more write instructions (e.g., WRMSR as described below) represented as block 224) to be executed and/or processed by processor core 200. In FIG. 2, instructions that may be decoded or otherwise handled by instruction unit 220 are represented as blocks with broken line borders because these instructions are not themselves hardware, but rather that instruction unit 220 may include hardware or logic capable of decoding or otherwise handling these instructions.

Any instruction format may be used in embodiments; for example, an instruction may include an opcode and one or more operands, where the opcode may be decoded into one or more micro-instructions or micro-operations for execution by an execution unit. Operands or other parameters may be associated with an instruction implicitly, directly, indirectly, or according to any other approach.

Configuration storage 230 may include any one or more MSRs or other registers or storage locations, one or more of which may be in a core, one or more of which may be in an uncore or system agent, etc. to control processor features, control and report on processor performance, handle system related functions, etc. In various embodiments, one or more of these registers or storage locations may or may not be accessible to application and/or user-level software, may be written to or programmed by software, a basic input/output system (BIOS), etc.

In embodiments, the instruction set of processor core 200 may include instructions to access (e.g., read and/or write) MSRs or other storage, such as an instruction to write to an MSR (WRMSR) and/or instructions to write to or program other registers or storage locations.

In embodiments, configuration storage 230 may include one or more MSRs, fields or portions of MSRs, or other programmable storage locations, such as LQ threshold MSR field 234 and XQ threshold MSR field 236, to store queue thresholds, such as LQ threshold 144 and XQ threshold 146, respectively. Differing embodiments may provide for such thresholds to be defined in different ways, e.g., as a number or count, as a lifetime, as a percent or proportion, etc.

Processor 600 may also include a mechanism to indicate support for and enumeration of dynamic cache fill prioritization capabilities according to embodiments. For example, in response to an instruction (e.g., in an Intel® x86 processor, a CPUID instruction, one or more processor registers (e.g., EAX, EBX, ECX, EDX) may return information to indicate whether, to what extent, how, etc. dynamic cache fill prioritization capabilities according to embodiments are supported (e.g., indication of range or choice of queue threshold number, lifetime, percent, etc.)

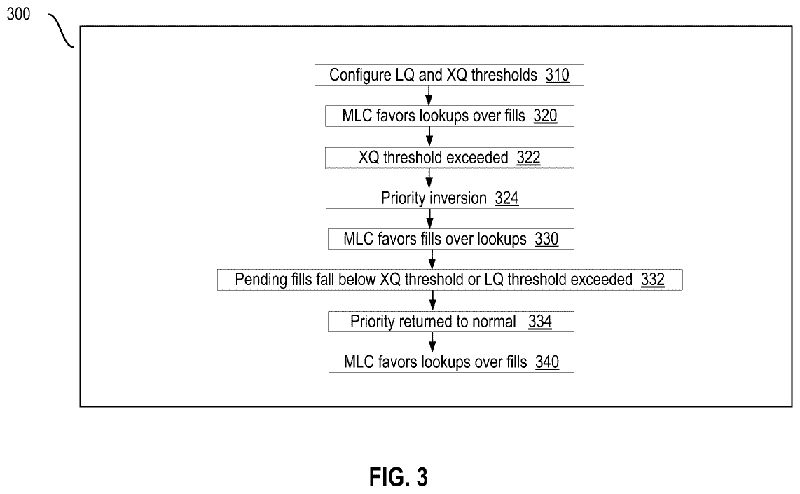

FIG. 3 illustrates a method 300 for dynamic cache fill prioritization according to an embodiment. Method 300 may be performed by and/or in connection with the operation of an apparatus based on a cache architecture such as that shown FIG. 1; therefore, all or any portion of the preceding description of or related to FIG. 2 may be applicable to method 300.

In 310, an MLC unit (e.g., MLC unit 110) may be configured with a local queue threshold (e.g., LQ threshold 144) and an external queue threshold (e.g., XQ threshold 146), for example by system software writing to one or more MSRs (e.g., including LQ threshold MSR field 234 and XQ threshold MSR field 236).

In 320, MLC unit 110 operates according to a policy that favors (e.g., gives a higher priority to) cache lookups over cache fills (typical/normal prioritization). In 322, the number of requests pending fill into the MLC exceeds the external queue threshold. In 324, in response to 322, the policy is dynamically (e.g., during operation of the MLC unit by the MLC unit hardware without re-configuration by software or firmware) switched to favor cache fills over cache lookups (priority inversion).

In 330, MLC unit 110 operates according to a policy that favors cache fills over cache lookups (inverted prioritization). In 332, either the number of pending fills falls below the external queue threshold or the number of requests from the nucleus core pending an MLC lookup increases above the local queue threshold. In 334, in response to 332, the policy is dynamically switched to favor cache lookups over cache fills (priority returned to normal).

In 340, MLC unit 110 operates according to a policy that favors cache lookups over cache fills (typical/normal prioritization).

Operation based on any threshold described above may vary in different embodiments. For example, an action may be taken in response to a threshold being reached or met, in response to a threshold being crossed (in a positive direction (exceeded) or a negative direction), etc.

### Example Apparatuses, Methods, Etc.

According to some examples, an apparatus (e.g., a processing device or system) includes a cache at a mid-level of a cache hierarchy; and a mid-level cache (MLC) unit including the cache, a local queue to store MLC lookup requests, an external queue to store MLC fill requests, and an MLC access control hardware. The MLC access control hardware is to dynamically switch prioritization of servicing the MLC lookup requests versus servicing the MLC fill requests.

Any such examples may include any or any combination of the following aspects. The MLC access control hardware is to dynamically switch the prioritization based, at least in part, on an external queue threshold. The external queue threshold is programmable. The MLC access control hardware includes a comparator to compare external queue occupancy with the external queue threshold to determine when to dynamically switch the prioritization. The MLC access control hardware, in response to a determination that the external queue occupancy exceeds the external queue threshold, is to dynamically switch the prioritization from favoring fill requests to favoring load requests. The MLC access control hardware, in response to a determination that the external queue occupancy is less than the external queue threshold, is to dynamically switch the prioritization from favoring load requests to favoring fill requests. The MLC access control hardware is to dynamically switch the prioritization based, at least in part, on a local queue threshold. The local queue threshold is programmable. The MLC access control hardware includes a comparator to compare local queue occupancy with the local queue threshold to determine when to dynamically switch the prioritization. The MLC access control hardware, in response to a determination that the local queue occupancy exceeds the local queue threshold, is to dynamically switch the prioritization from favoring load requests to favoring fill requests. The MLC access control hardware includes a multiplexer to select between an MLC lookup request and an MLC fill request based, at least in part, on at least one of a first comparison between an external queue threshold and an external queue occupancy and a second comparison between a local queue threshold and a local queue occupancy.

According to some examples, a method includes comparing, by mid-level cache (MLC) access control hardware, occupancy of a queue with a threshold, wherein the queue is for access to an MLC within a cache hierarchy of a processor; and dynamically switching, by the MLC access control hardware based on the comparing, prioritization of servicing MLC lookup requests versus servicing MLC fill requests.

Any such examples may include any or any combination of the following aspects. The threshold is programmable. The queue is an external queue to store MLC fill requests. The MLC access control hardware, in response to a determination that the occupancy exceeds the threshold, is to dynamically switch the prioritization from favoring fill requests to favoring load requests. The MLC access control hardware, in response to a determination that the occupancy is less than the threshold, is to dynamically switch the prioritization from favoring load requests to favoring fill requests. The queue is a local queue to store MLC lookup requests. The MLC access control hardware, in response to a determination that the occupancy exceeds the threshold, is to dynamically switch the prioritization from favoring load requests to favoring fill requests.

According to some examples, a system includes a system memory; a plurality of caches to store data from the system memory, the plurality of caches including a mid-level cache (MLC); and an MLC unit including the MLC, a local queue to store MLC lookup requests, and an external queue to store MLC fill requests, and an MLC access control hardware, wherein the MLC access control hardware is to dynamically switch prioritization of servicing the MLC lookup requests versus servicing the MLC fill requests.

Any such examples may include any or any combination of the following aspects. The plurality of caches are arranged in a cache hierarchy, wherein the MLC is between a first cache and a second cache in the cache hierarchy. The MLC access control hardware is to dynamically switch the prioritization based, at least in part, on an external queue threshold. The external queue threshold is programmable. The MLC access control hardware includes a comparator to compare external queue occupancy with the external queue threshold to determine when to dynamically switch the prioritization. The MLC access control hardware, in response to a determination that the external queue occupancy exceeds the external queue threshold, is to dynamically switch the prioritization from favoring fill requests to favoring load requests. The MLC access control hardware, in response to a determination that the external queue occupancy is less than the external queue threshold, is to dynamically switch the prioritization from favoring load requests to favoring fill requests. The MLC access control hardware is to dynamically switch the prioritization based, at least in part, on a local queue threshold. The local queue threshold is programmable. The MLC access control hardware includes a comparator to compare local queue occupancy with the local queue threshold to determine when to dynamically switch the prioritization. The MLC access control hardware, in response to a determination that the local queue occupancy exceeds the local queue threshold, is to dynamically switch the prioritization from favoring load requests to favoring fill requests. The MLC access control hardware includes a multiplexer to select between an MLC lookup request and an MLC fill request based, at least in part, on at least one of a first comparison between an external queue threshold and an external queue occupancy and a second comparison between a local queue threshold and a local queue occupancy.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures—In-Order and Out-of-Order Core Block Diagram.

FIG. 6A is a block diagram illustrating both an example in-order pipeline and an example register renaming, out-of-order issue/execution pipeline according to examples. FIG. 6B is a block diagram illustrating both an example in-order architecture core and an example register renaming, out-of-order issue/execution architecture core to be included in a processor according to examples. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6B may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6B shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry.

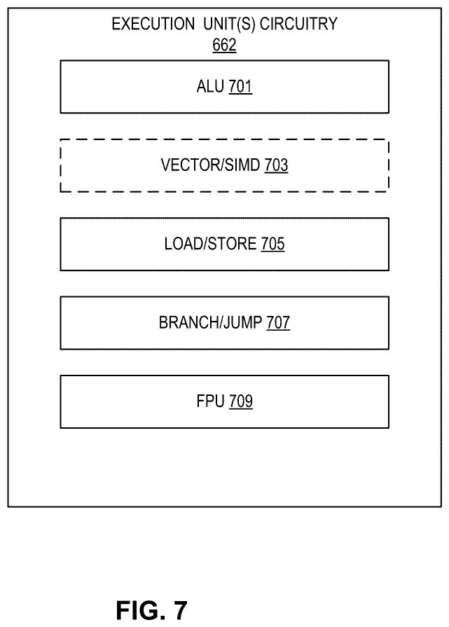

FIG. 7 illustrates examples of execution unit(s) circuitry, such as execution unit(s) circuitry 662 of FIG. 6B. As illustrated, execution unit(s) circuitry 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

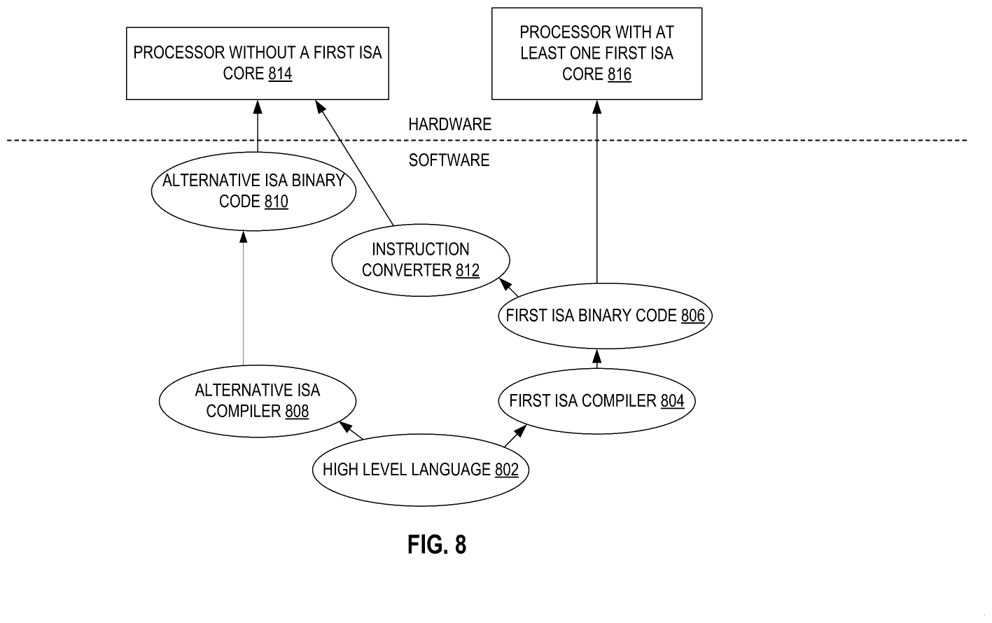

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a cache at a mid-level of a cache hierarchy; and
a mid-level cache (MLC) unit including the cache, a local queue to store MLC lookup requests, and an external queue to store MLC fill requests, and an MLC access control hardware, wherein the MLC access control hardware is to dynamically switch prioritization of servicing the MLC lookup requests versus servicing the MLC fill requests.

2. The apparatus of claim 1, wherein the MLC access control hardware is to dynamically switch the prioritization based, at least in part, on an external queue threshold.

3. The apparatus of claim 2, wherein the external queue threshold is programmable.

4. The apparatus of claim 3, wherein the MLC access control hardware includes a comparator to compare external queue occupancy with the external queue threshold to determine when to dynamically switch the prioritization.

5. The apparatus of claim 3, wherein the MLC access control hardware, in response to a determination that external queue occupancy exceeds the external queue threshold, is to dynamically switch the prioritization from favoring fill requests to favoring load requests.

6. The apparatus of claim 5, wherein the MLC access control hardware, in response to a determination that the external queue occupancy is less than the external queue threshold, is to dynamically switch the prioritization from favoring load requests to favoring fill requests.

7. The apparatus of claim 1, wherein the MLC access control hardware is to dynamically switch the prioritization based, at least in part, on a local queue threshold.

8. The apparatus of claim 7, wherein the local queue threshold is programmable.

9. The apparatus of claim 8, wherein the MLC access control hardware includes a comparator to compare local queue occupancy with the local queue threshold to determine when to dynamically switch the prioritization.

10. The apparatus of claim 8, wherein the MLC access control hardware, in response to a determination that local queue occupancy exceeds the local queue threshold, is to dynamically switch the prioritization from favoring load requests to favoring fill requests.

11. The apparatus of claim 1, wherein the MLC access control hardware includes a multiplexer to select between an MLC lookup request and an MLC fill request based, at least in part, on at least one of a first comparison between an external queue threshold and an external queue occupancy and a second comparison between a local queue threshold and a local queue occupancy.

12. A method comprising:
comparing, by mid-level cache (MLC) access control hardware, occupancy of a queue with a threshold, wherein the queue is for access to an MLC within a cache hierarchy of a processor; and
dynamically switching, by the MLC access control hardware based on the comparing, prioritization of servicing MLC lookup requests versus servicing MLC fill requests.

13. The method of claim 12, wherein the threshold is programmable.

14. The method of claim 13, wherein the queue is an external queue to store MLC fill requests.

15. The method of claim 14, wherein the MLC access control hardware, in response to a determination that the occupancy exceeds the threshold, is to dynamically switch the prioritization from favoring fill requests to favoring load requests.

16. The method of claim 15, wherein the MLC access control hardware, in response to a determination that the occupancy is less than the threshold, is to dynamically switch the prioritization from favoring load requests to favoring fill requests.

17. The method of claim 13, wherein the queue is a local queue to store MLC lookup requests.

18. The method of claim 17, wherein the MLC access control hardware, in response to a determination that the occupancy exceeds the threshold, is to dynamically switch the prioritization from favoring load requests to favoring fill requests.

19. A system comprising:
a system memory;
a plurality of caches to store data from the system memory, the plurality of caches including a mid-level cache (MLC); and
an MLC unit including the MLC, a local queue to store MLC lookup requests, and an external queue to store MLC fill requests, and an MLC access control hardware, wherein the MLC access control hardware is to dynamically switch prioritization of servicing the MLC lookup requests versus servicing the MLC fill requests.

20. The system of claim 19, wherein the plurality of caches are arranged in a cache hierarchy, wherein the MLC is between a first cache and a second cache in the cache hierarchy.
